(19) United States
(12) Patent Application Publication
(10) Pub. No.: US 2012/0026541 A1
(43) Pub. Date: Feb. 2, 2012

(54) PRINTING CONTROL APPARATUS, PRINTING APPARATUS, AND PRINT PREVIEW METHOD

(75) Inventor: Hideyuki Kobayashi, Tokyo (JP)

(73) Assignee: CANON KABUSHIKI KAISHA, Tokyo (JP)

(21) Appl. No.: 13/180,482

(22) Filed: Jul. 11, 2011

(30) Foreign Application Priority Data
Jul. 27, 2010 (JP) 2010-168426

(51) Int. Cl. G06F 3/12

(52) U.S. Cl. 358/1.15; 358/527

(57) ABSTRACT

This invention makes it possible to match the size of a preview image on a display device and that of an image printed on paper upon preview display of a print image. This invention is made in consideration of the fact that individual display devices which display preview images have unique resolutions. According to this invention, in displaying a preview image, the resolution of a display device used is recognized, preview data is generated in accordance with the resolution of the display device, and the preview data is displayed. This makes it possible to display a preview image with the same size as the print size on the display device.

### BACKGROUND OF THE INVENTION

1. Field of the Invention

The present invention relates to a printing control apparatus, a printing apparatus, and a print preview method. Particularly, the present invention relates to a printing control apparatus, a printing apparatus, and a print preview method which, for example, perform a print preview of image data used to print an image.

2. Description of the Related Art

A print preview function has conventionally been known as a function of confirming the print result before printing for the sake of convenience in printing. Prevention of a failure in printing by print preview confirmation is effective especially in a large-format printer which prints on a large sheet of paper because a failure in printing has a serious influence in terms of waste of, for example, paper, ink, and time.

Most of conventional print preview techniques are normally used to confirm the actual print orientation and layout using a symbol or an illustration instead of using a real image. However, there has been a proposal to implement, in a printer driver, a print preview function which uses a real image, and match the print size and the size of a preview displayed on a screen, thereby faithfully reproducing a print result on the screen (see, for example, Japanese Patent Laid-Open Nos. 2001-171214 and 2007-104250).

The above-mentioned conventional real image preview techniques pose the following problems.

More specifically, to match the size of a preview on the display screen and that of the print result, a dedicated display device with the same size as a predetermined print size is assumed to used. Therefore, the above-mentioned techniques cannot cope with an image of a size other than a preset standard size.

Also, a display area for a preview image is determined on the display screen in advance, and image data is resized to that of the display area, so the size of the print result depends on the size of the screen which displays a preview. Therefore, the above-mentioned techniques cannot cope with arbitrary print data having a predefined print size.

### SUMMARY OF THE INVENTION

Accordingly, the present invention is conceived as a response to the above-described disadvantages of the conventional art.

For example, a printing control apparatus, a printing apparatus, and a print preview method according to this invention are capable of more flexibly previewing a real image even for a print image with an arbitrary size.

According to one aspect of the present invention, there is provided a printing control apparatus which controls to perform a preview of an image on a screen of a display device before the image is printed on a printing medium, comprising: an acquisition unit configured to acquire a number of pixels and a size of the screen of the display device, which allow the preview thereon; a calculation unit configured to calculate a display resolution used for the preview on the display device, based on the number of pixels and the size which are acquired by the acquisition unit; an input unit configured to input image data used to print the image; a generation unit configured to generate preview data used for the preview, based on the image data input by the input unit and the display resolution of the display device calculated by the calculation unit; and a display control unit configured to control the display device to display a preview image by outputting the preview data generated by the generation unit to the display device.

According to another aspect of the present invention, there is provided a non-transitory computer-readable storage medium storing a computer-executable program, the computer-executable program realizing a function implemented by each unit recited in the above apparatus.

According to still another aspect of the present invention, there is provided a printing apparatus connected to the above printing control apparatus or a printing apparatus which integrates the above printing control apparatus.

According to still another aspect of the present invention, there is provided a print preview method for a printing control apparatus which controls to perform a preview of an image on a screen of a display device before the image is printed on a printing medium, comprising: acquiring a number of pixels and a size of the screen of the display device, which allow the preview thereon; calculating a display resolution used for the preview on the display device, based on the acquired number of pixels and the acquired size; inputting image data used to print the image; generating preview data used for the preview, based on the input image data and the calculated resolution of the display device; and controlling the display device to display a preview image by outputting the generated preview data to the display device.

The invention is particularly advantageous since in previewing an image on a display device based on image data used to print the image, the display resolution of the display device is calculated based on the number of pixels and the size of the display device, and the image is previewed based on the image data. This makes it possible to match the size of a preview displayed on the display device and that of a real image upon printing. This, in turn, makes it possible to confirm an image approximate to the print result on the display device.

Further features of the present invention will become apparent from the following description of exemplary embodiments with reference to the attached drawings.

### BRIEF DESCRIPTION OF THE DRAWINGS

FIG. 1 is a block diagram showing the configuration of a printing system according to an exemplary embodiment of the present invention.

FIG. 2 is a block diagram showing the hardware configuration of a host apparatus.

FIGS. 3A and 3B are external perspective views of an inkjet printer which discharges and prints ink on a printing medium.

FIGS. 4A and 4B are views illustrating examples of user interfaces displayed on a print preview control unit.

FIGS. 5A and 5B are views illustrating user interfaces which display pieces of information of display devices.

FIGS. 6A and 6B are views illustrating user interfaces used to add or edit pieces of information of display devices.

FIG. 7 is a flowchart showing preview display processing.

FIG. 8 is a flowchart showing display device setting processing.

FIG. 9 is a flowchart showing display device editing processing.

### DESCRIPTION OF THE EMBODIMENTS

An exemplary embodiment of the present invention will now be described in detail in accordance with the accompanying drawings. Note that arrangements to be disclosed in the following embodiments are merely illustrative, and the present invention is not limited to the configurations or arrangements shown in the drawings.

In this specification, the terms “print” and “printing” not only include the formation of significant information such as characters and graphics, but also broadly include the formation of images, figures, patterns, and the like on a print medium, or the processing of the medium, regardless of whether they are significant or insignificant and whether they are so visualized as to be visually perceivable by humans.

Also, the term “print medium” not only includes a paper sheet used in common printing apparatuses, but also broadly includes materials, such as cloth, a plastic film, a metal plate, glass, ceramics, wood, and leather, capable of accepting ink.

Furthermore, the term “ink” (to be also referred to as a “liquid” hereinafter) should be extensively interpreted similar to the definition of “print” described above. That is, “ink” includes a liquid which, when applied onto a print medium, can form images, figures, patterns, and the like, can process the print medium, and can process ink. The process of ink includes, for example, solidifying or insolubilizing a coloring agent contained in ink applied to the print medium.

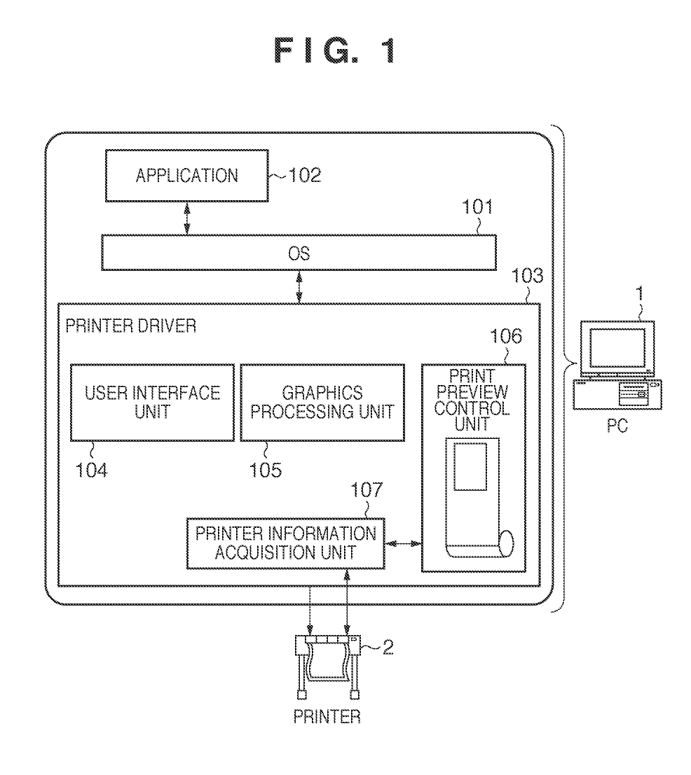

FIG. 1 is a block diagram showing the schematic configuration of a printing system according to an embodiment of the present invention. As can be seen from FIG. 1, the system includes a host apparatus (to be simply referred to as a host hereinafter) 1 such as a personal computer (PC), and a printer (printing apparatus) 2 which prints on a printing medium with a relatively large size such as A0 or B0. The printer 2 is, for example, an inkjet printer which discharges ink to print on a printing medium in accordance with the inkjet printing method. Although only one printer is used in this case, the host 1 and printer 2 may be connected to each other via a network so that the host 1 can be connected to a plurality of printers.

An operating system (to be abbreviated as an OS hereinafter) 101, a printer driver 103 serving as software which controls the printer 2, and an application 102 which generates various documents are installed on the host 1. The OS 101 and printer driver 103 run on the host 1 so that the printer 2 prints various documents generated by the application 102.

Also, the printer driver 103 includes the following four functional units.

More specifically, the printer driver 103 includes: (1) a user interface unit 104 which accepts input by the user; (2) a graphics processing unit 105 which generates print data to be transmitted to the printer 2; (3) a print preview control unit 106 which controls a print preview used to confirm, for example, the print layout; and (4) a printer information acquisition unit 107 which acquires various types of printer information such as the width information of roll paper attached to the printer 2, and the current state of the printer 2.

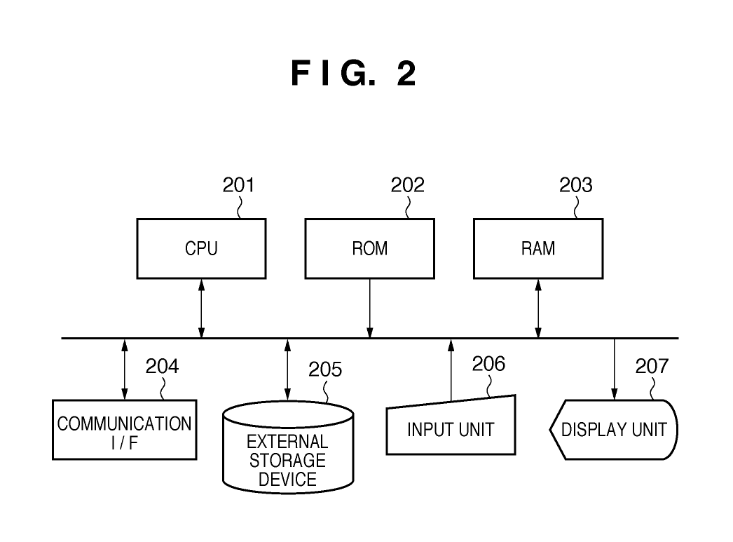

FIG. 2 is a block diagram showing the hardware configuration of the host 1.

Referring to FIG. 2, a CPU 201 performs various types of control of the entire host 1. A ROM 202 stores an initialization program and various types of data to be executed by the CPU 201 at the time of startup of the host 1. A RAM 203 is used as a main memory or a working area for the CPU 201.

An external storage device 205 uses, for example, a hard disk (HDD) and stores various programs. A program (printer driver) for implementing processing shown in flowcharts to be described later is loaded from the external storage device (HDD) 205 into the RAM 203. An input unit 206 includes, for example, a keyboard or a pointing device, and inputs various instructions to the CPU 201. A display unit 207 which includes, for example, an LCD or a CRT performs various types of display under the control of the CPU 201. A communication interface (I/F) 204 is used to communicate with a peripheral apparatus such as the printer 2. The communication I/F 204 may be locally connected to a single peripheral apparatus or connected to it via a network.

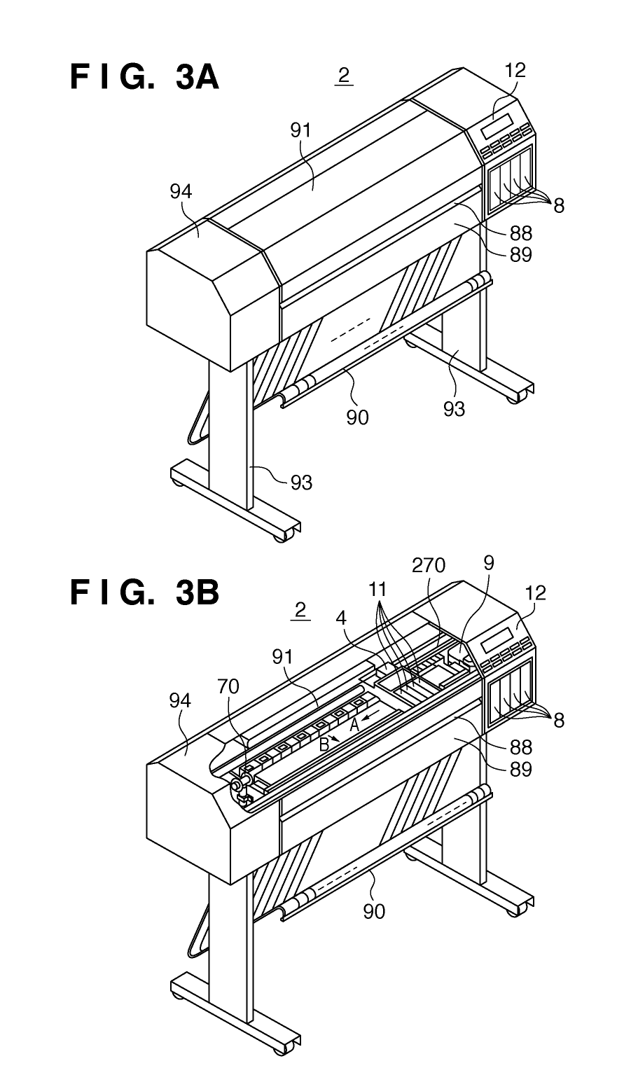

FIGS. 3A and 3B are external perspective views of an inkjet printer (to be simply referred to as a printer hereinafter) which discharges ink to print on a printing medium. FIG. 3A is a perspective view showing the state in which an upper cover is attached to the printer, and FIG. 3B is a perspective view showing the state in which the upper cover is detached.

As shown in FIGS. 3A and 3B, a manual feed port 88 is provided in the front surface of the printer 2, and a roll paper cassette 89 which is openable/closable with respect to the front surface is provided in its lower portion, so a printing medium such as printing paper is supplied from the manual feed port 88 or roll paper cassette 89 into the printer 2. In this manner, the printer 2 can print a document with an arbitrary length within an acceptable length defined by the printer driver 103 from the roll paper cassette 89. Also, a paper feed port for cut paper may be provided to make it possible to print not only on roll paper but also on cut paper. In this case, two paper feed ports are provided.

The printer 2 includes an apparatus main body 94 supported by two legs 93, a stacker 90 which stacks a delivered printing medium, and a see-through, transparent, openable/closable upper cover 91. Also, an operation panel 12, an ink supply unit, and ink tanks 8 are disposed on the right side of the apparatus main body 94.

As shown in FIG. 3B, the printer 2 also includes a conveyance roller 70 used to convey a printing medium in a direction (the sub-scanning direction) indicated by an arrow B, and a carriage 4 which is guided and supported to be reciprocally movable in the widthwise direction (a direction indicated by an arrow A, that is, the main scanning direction) of the printing medium. The printer 2 moreover includes a carriage motor (not shown) and a carriage belt (to be simply referred to as a belt hereinafter) 270 which are used to reciprocally move the carriage 4 in the direction indicated by the arrow A, and an inkjet print head (to be simply referred to as a print head hereinafter) 11 attached to the carriage 4. The printer 2 moreover includes a suction type ink recovery unit 9 used to supply ink and to cancel an ink discharge failure due to, for example, clogging of the orifice of the print head 11.

In case of the printer 2, the print head 11 including four heads is attached to the carriage 4 in correspondence with four color inks so as to perform color printing on a printing medium. More specifically, the print head 11 includes, for example, a K head which discharges K (black) ink, a C head which discharges C (cyan) ink, an M head which discharges M (magenta) ink, and a Y head which discharges Y (yellow) ink.

To print on a printing medium, the printing medium is conveyed to the printing start position by the conveyance roller 70, and then an operation of scanning the print head 11 in the main scanning direction by the carriage 4, and an operation of conveying the printing medium in the sub-scanning direction by the conveyance roller 70, are repeated. Thus, printing on the entire printing medium is performed.

More specifically, the carriage 4 moves in the direction indicated by the arrow A shown in FIG. 3B by means of the belt 270 and the carriage motor (not shown), thereby printing on a printing medium. When the carriage 4 is returned to the position (home position) before scanning, the printing medium is conveyed in the sub-scanning direction (the direction indicated by the arrow B) by the conveyance roller 70, and then the carriage is scanned again in the direction indicated by the arrow A, thereby printing, for example, an image or a text on the printing medium. When printing on one printing medium is complete upon repeating the above-mentioned operation, this printing medium is discharged into the stacker 90, and printing on one sheet is completed.

Note that this printer can print on a printing medium with a relatively large size such as B0 or A0 corresponding to cut paper. Although a large-format inkjet printer is thus used in this embodiment, other types of printers may be used. Examples of other types of printers include a consumer-oriented inkjet printer compatible with A3 or A4-sized paper, and a multifunctional printer (MFP) which integrates a printer unit, a scanner unit, and a monitor unit. Also, the printing method applicable to the printer includes not only the inkjet printing method but also, for example, the electrophotographic method. In this case, the monitor unit employs a large-sized monitor which matches the size of a printing medium. Also, the printer 2 may include each configuration shown in FIG. 2, like the host 1, and can execute the same processing as that executed in the host 1 by loading a program stored in the ROM 202 or external storage device 205 into the RAM 203 and executing the program by the CPU 201. The display unit 207 shown in FIG. 2 corresponds to the monitor of the printer 2.

Although a printing system including a host and printer will be taken as an example in this embodiment, other system configurations may be used. For example, a configuration according in which a printing control apparatus having a print preview function is integrated into a printer may be adopted. In this case, either a configuration in which a monitor used as a preview screen is integrated into a printer or that which is connected to an external monitor may be adopted. When an external monitor is used, the printing control apparatus outputs preview data generated by processing to be described later to the external monitor, and performs its display control.

A print preview display procedure which uses the print preview control unit 106 according to a user's operation will be described next. The following processing is performed by loading a program stored in the external storage device 205 of the host 1 into the RAM 203, and executing the program by the CPU 201. In this case, the host 1 functions as a printing control apparatus.

First, the user generates a document using the application 102, and issues a print instruction from, for example, a menu of the application 102 to activate a print dialog. In general, setting of a selected printer driver can be confirmed or changed by depressing, for example, a property button from a print dialog of the application 102.

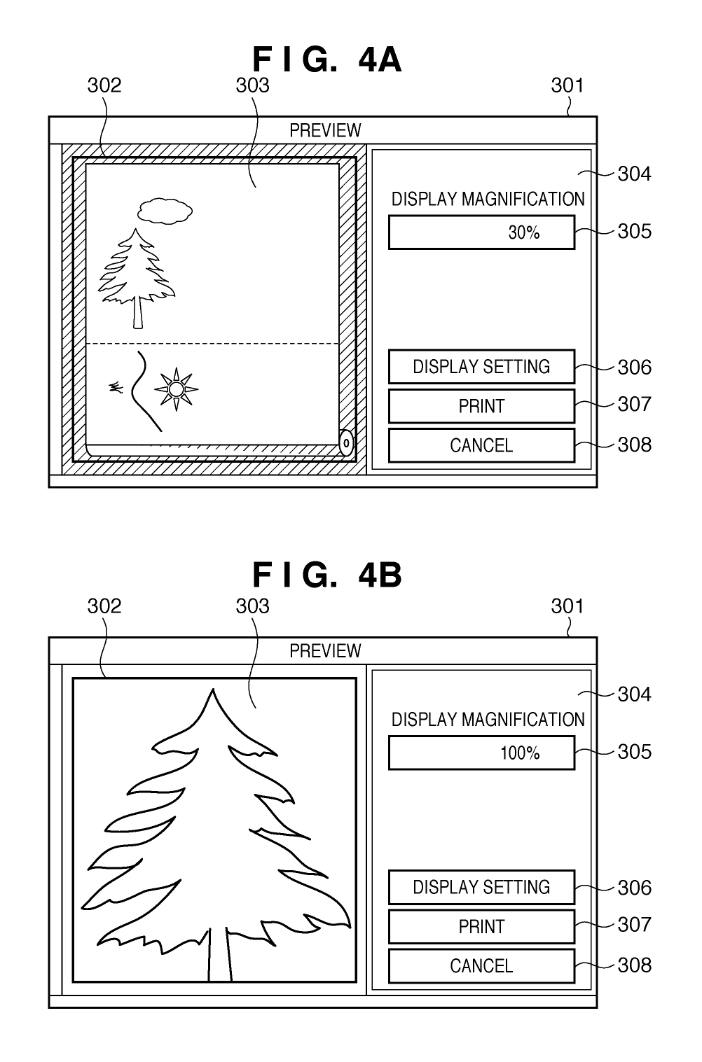

FIGS. 4A and 4B are views illustrating examples of user interfaces which allow the print preview control unit 106 to display a print preview on the display unit 207. FIG. 4A shows a preview at a display magnification of 30%, and FIG. 4B is a preview at a display magnification of 100%.

Referring to FIGS. 4A and 4B, reference numeral 301 denotes a print preview dialog including a print preview display portion 302 and setting display/change portion 304. An image 303 to be printed on a printing medium such as printing paper is displayed in the print preview display portion 302. The setting display/change portion 304 includes a preview display magnification designation portion 305, display device setting dialog display button 306, print button 307, and cancel button 308. The print image 303 with a magnification designated in the preview display magnification designation portion 305 is displayed in the print preview display portion 302.

If the user confirms the print image displayed in the print preview display portion 302, and wants to print it using the confirmed details, he or she depresses the print button 307 to output image data to the printer 2 and print it by the printer 2. If the user confirms the print image displayed in the print preview display portion 302, but does not want to print it using the confirmed details, he or she depresses the cancel button 308 to close the print preview dialog 301.

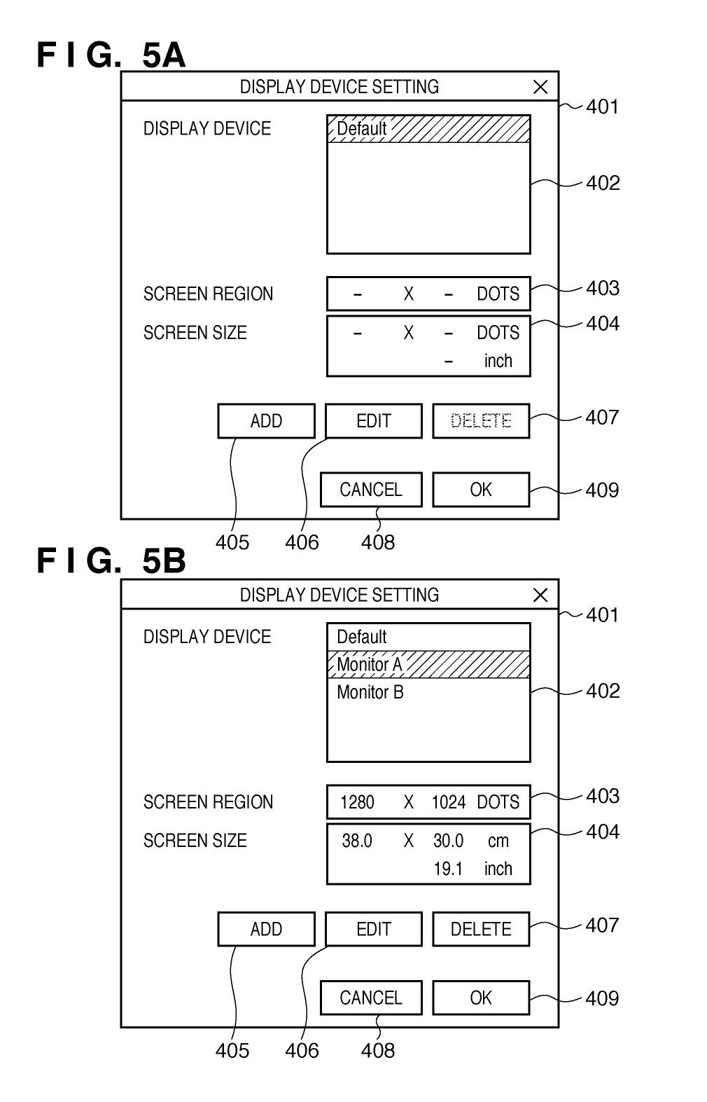

FIGS. 5A and 5B are views illustrating examples of user interfaces used to display and set a list of display devices on which print previews are displayed. Although the display unit 207 of the host 1 serves as a default display device in this printing system, another display may be set as a display device used for a print preview. FIG. 5A shows the state in which only a default is set as a display device, and FIG. 5B shows the state in which another display is set as a display device.

Referring to FIGS. 5A and 5B, reference numeral 401 denotes a display device setting dialog. A display device list portion 402 displays a list of display devices registered in the print preview control unit 106, and the currently selected display device is highlighted with an inverted color. A screen region display portion 403 displays the number of pixels in the horizontal and vertical directions on a screen associated with the currently selected display device. A screen size display portion 404 displays the horizontal and vertical sizes and the number of inches of the screen associated with the currently selected display device.

In generating a preview image, the resolution that is the number of pixels per inch on a display device selected in the display device list portion 402 is calculated based on the number of pixels on a screen associated with the display device, and the screen size, and a preview image is generated at the calculated resolution.

In the initial state of the print preview control unit 106, a default display device is defined. The initial value of the default display device has an undefined screen region and screen size, and only the resolution that is the number of pixels per inch is defined. When the default display device is displayed, a symbol “−” indicating an undefined state is displayed in the screen region display portion 403 and screen size display portion 404, as shown in FIG. 5A.

In adding, editing, and deleting a display device, an add button 405, an edit button 406, and a delete button 407, respectively, are depressed. Upon depressing a cancel button 408, the display device setting dialog 401 is closed without reflecting the operation details. Upon depressing an OK button 409, the display device setting dialog 401 is closed after reflecting the operation details. Note that when a single display device is available, the delete button 407 is disabled, as shown in FIG. 5A.

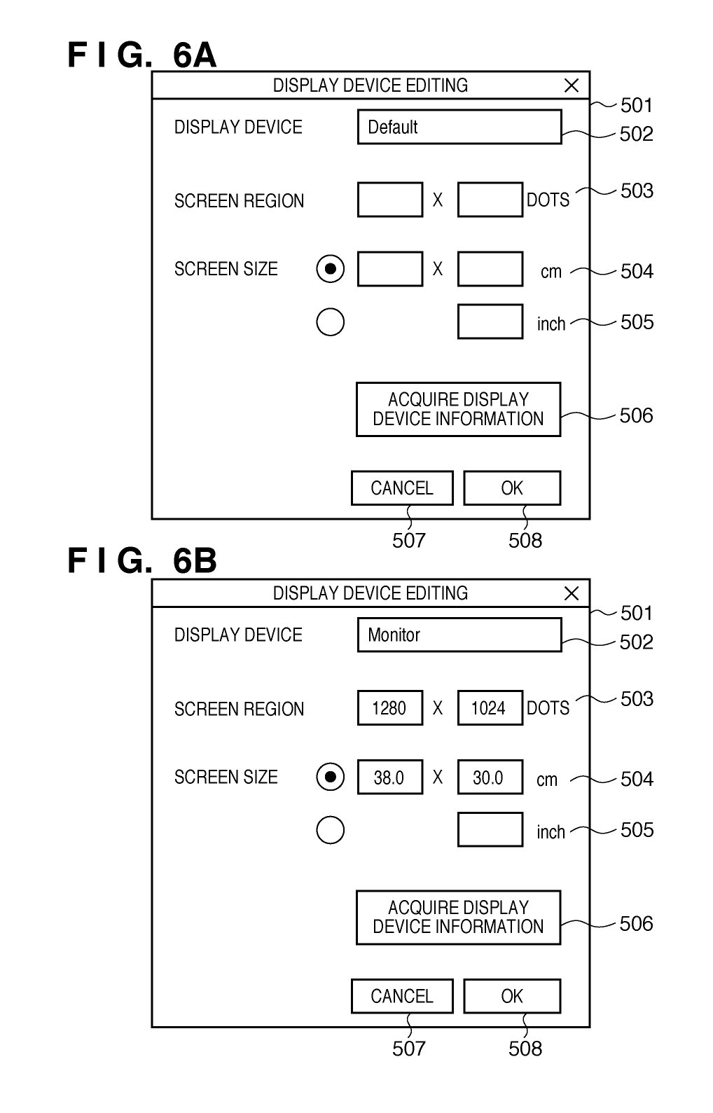

FIGS. 6A and 6B are views illustrating examples of user interfaces used to add a display device. FIG. 6A shows a screen before an editing operation for addition, and FIG. 6B shows a screen during editing for addition or at the end of editing. Referring to FIGS. 6A and 6B, reference numeral 501 denotes a display device editing dialog.

In adding or editing a display device, a display device name editing portion 502 displays the name of an input display device to set this display device in an editable state. A screen region editing portion 503 displays the input number of dots to set this number in an editable state. A screen size editing portion 504 displays the horizontal and vertical sizes of an input screen to set these sizes in an editable state. A screen size editing portion 505 displays the number of inches of an input screen to set this number in an editable state. The screen size editing portions 504 and 505 become effective only in an input portion selected by a radio button. A display device information acquire button 506 is used to automatically acquire a screen region and screen size. Upon depressing the display device information acquire button 506, a screen region and screen size stored in the RAM 203 or external storage device 205 of the host 1 are acquired and reflected on the screen region editing portion 503 and screen size editing portion 504, respectively. Upon depressing a cancel button 507, the display device editing dialog 501 is closed without reflecting the operation details. Upon depressing an OK button 508, the display device editing dialog 501 is closed after reflecting the operation details.

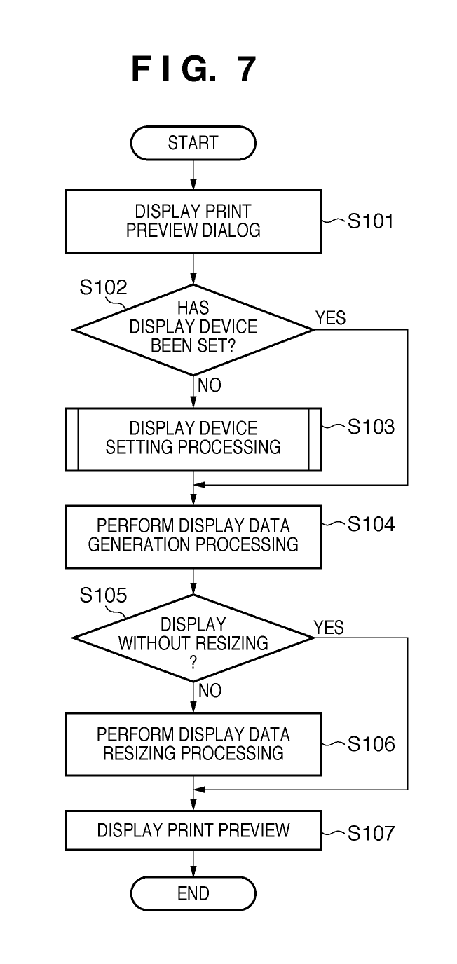

Print preview display processing provided with the above-mentioned configuration will be described in detail with reference to flowcharts shown in FIGS. 7 to 9.

First, in step S101, the print preview dialog 301 is displayed. In step S102, it is determined whether or not a display device other than a default in an initial value setting state has been registered in the print preview control unit 106. Note that a default display device in an initial value setting state is recognizable by confirming whether or not the screen region and screen size are undefined. If NO is determined in step S102, the process advances to step S103; otherwise, the process directly advances to step S104.

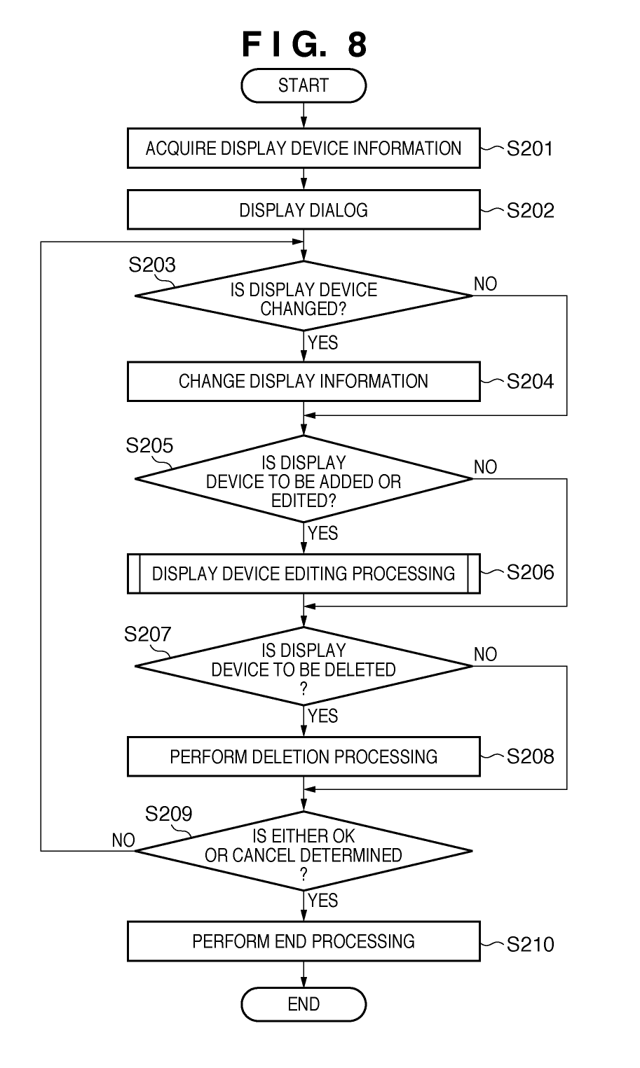

FIG. 8 is a flowchart showing details of display device setting processing in step S103. Detailed processing in step S103 will be described herein with reference to FIG. 8.

First, in step S201, all information of display devices registered in the print preview control unit 106 is acquired. The information to be acquired includes the name of each display device, the screen region, the screen size, the resolution that is the number of pixels per inch on each display device, which are associated with this display device, and the currently selected display device. After acquisition, the process advances to step S202. In step S202, the display device setting dialog 401 is displayed using the information acquired in step S201.

If only a default display device set as an initial value is available, the display device setting dialog 401 displays a symbol “−” indicating an undefined state for both the screen region and the screen size, and the delete button is disabled, as shown in FIG. 5A. If a plurality of display devices are available, the display device setting dialog 401 displays the plurality of display devices in the display device list portion 402, and the selected display device is highlighted with an inverted color, as shown in FIG. 5B. The screen region display portion 403 and screen size display portion 404 display the screen region and screen size, respectively, of the currently selected display device. After dialog display, the process advances to step S203.

In step S203, it is determined whether or not the display device selected in the display device list portion 402 is changed. If YES is determined in step S203, the process advances to step S204, in which information associated with a newly selected display device is displayed in the screen region display portion 403 and screen size display portion 404. On the other hand, if NO is determined in step S203, the process skips step S204 and advances to step S205.

In step S205, it is determined whether or not one of the add button 405 and edit button 406 is selected. If YES is determined in step S205, the process advances to step S206; otherwise, the process skips step S206 and advances to step S207.

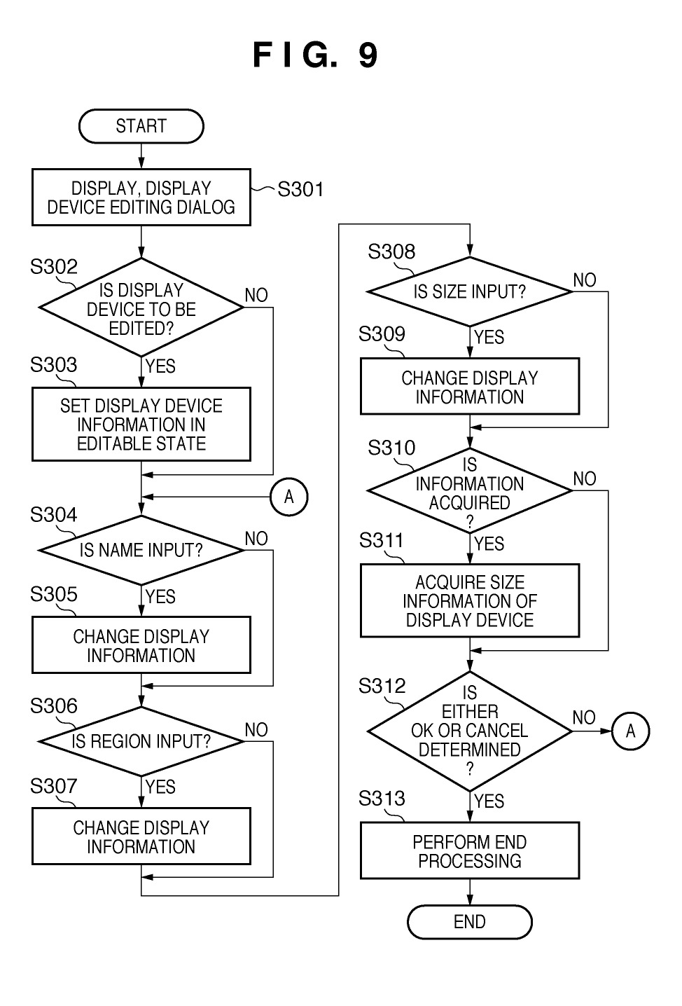

FIG. 9 is a flowchart showing details of display device editing processing in step S206. Detailed processing in step S206 will be described herein with reference to FIG. 9.

First, in step S301, the display device editing dialog 501 is displayed, and the process advances to step S302, where it is determined whether or not one of edition and addition of a display device will be performed. If YES is determined in step S302, the process advances to step S303; otherwise, the process directly advances to step S304. In step S303, the name of the currently selected display device, the screen region, and the screen size are acquired, as shown in FIG. 6B. These pieces of information are displayed in the display device name editing portion 502, screen region editing portion 503, and screen size editing portion 504 to set them in an editable state.

In step S304, it is determined whether or not the name of a display device is input. If YES is determined in step S304, the process advances to step S305; otherwise, the process skips step S305 and advances to step S306. In step S305, the input information is displayed in the display device name editing portion 502. In step S306, it is determined whether or not screen region information is input. If YES is determined in step S306, the process advances to step S307; otherwise, the process skips S307 and advances to step S308. In step S307, the input information is displayed in the screen region editing portion 503.

In step S308, it is determined whether or not screen size information is input. Screen size information can be input using the horizontal and vertical sizes of the screen (unit: cm) or using the dimension of a diagonal line of the screen (unit: inches). This can be performed by selecting an item to be input by a radio button. If NO is determined in step S308, the process skips step S309 and advances to step S310. If YES is determined in step S308, the process advances to step S309, in which the input information is displayed in the screen size editing portion 504 or 505.

In step S310, it is determined whether or not the display device information acquire button 506 is pressed. If YES is determined in step S310, the process advances to step S311. On the other hand, if NO is determined in step S310, the process skips step S311 and advances to step S312. In step S311, the screen region and screen size associated with the currently used display device are acquired.

Because those pieces of information are normally managed by, for example, the OS 101 of the host 1, their values are acquired by sending a query from the print preview control unit 106 to the system. Also, screen size information, for example, is defined by, for example, EDID (Extended Display Identification Data) in the standard stipulated by VESA (Video Electronics Standards Association). Hence, a method of directly acquiring those pieces of information via a video interface may be adopted. When those pieces of information can be acquired, they are displayed in the screen region editing portion 503 and screen size editing portion 504. The pieces of acquired information may be displayed in a non-editable state.

In step S312, it is determined whether or not one of the cancel button 507 and the OK button 508 is pressed. If YES is determined in step S312, the process advances to step S313; otherwise, the process returns to step S304.

If the cancel button 507 is pressed in step S312, in step S313 all processing details executed in the display device editing dialog 501 are canceled, the display device editing dialog 501 is closed, and the process ends. On the other hand, if the OK button 508 is pressed in step S312, in step S313 the resolution that is the number of pixels per inch on the display device is calculated based on the currently set information.

If the horizontal and vertical sizes of the screen is set as the screen size, the calculation expressions of the resolution are (Number of Dots in Horizontal Direction in Screen Region)/(Horizontal Dimension of Screen (cm))×2.54, and (Number of Dots in Vertical Direction in Screen Region)/(Vertical Dimension of Screen (cm))×2.54.

On the other hand, if the dimension of a diagonal line of the screen is set as the screen size, the number of dots on the diagonal line can be obtained by calculating the square root of the sum of the square of the number of dots in the horizontal direction and the square of the number of dots in the vertical direction, so the calculation expression of the resolution is (Number of Dots on Diagonal Line of Screen)/(Inch Size of Diagonal Line of Screen).

Then, the acquired resolution (the number of pixels per inch) of the display device is temporarily stored as information of the display device registered in the print preview control unit 106 on the screen in association with the name, screen region, and screen size of the display device. After that, the display device editing dialog 501 is closed, and the process ends. Note that the added and edited display device information is additionally displayed in the display device setting dialog 401.

Referring back to FIG. 8, it is determined in step S207 whether or not the delete button 407 is selected. If YES is determined in step S207, the process advances to step S208. In step S208, to perform display device deletion processing, the display information, displayed in the display device setting dialog 401, to be deleted, and the information of the display device, registered in the print preview control unit 106 on the screen, to be deleted, are temporarily stored. In step S209, it is determined whether or not one of the cancel button 408 and the OK button 409 is pressed. If YES is determined in step S209, the process advances to end processing in step S210; otherwise, the process returns to step S203.

If the cancel button 408 is selected, in step S210, all of the information which has been used to add or edit in connection with a display device in step S206 and information which has been determined to be deleted in connection with the display device in step S208 are discarded, the display device setting dialog 401 is closed, and the process ends. On the other hand, if the OK button 409 is selected, in step S210, the information of the display device registered in the print preview control unit 106 is updated using the information which has been used to add or edit in connection with the display device in step S206 and the information which has been determined to be deleted in connection with the display device in step S208. After updating, the display device setting dialog 401 is closed, and the process ends.

Referring back to FIG. 7, in step S104, preview data to be displayed in the image 303 of the print preview dialog 301 is generated. The resolution of preview data to be generated is obtained using information of the number of pixels per inch on the display device, which is stored in association with the currently selected display device, among the pieces of information of the display device registered in the print preview control unit 106. Preview data is generated at the resolution obtained from print data acquired by the printer driver.

In step S105, it is determined whether or not the display magnification of the print preview dialog 301 is 100% (meaning “no resizing”). If NO is determined in step S105, the process advances to step S106; otherwise, the process skips step S106 and advances to step S107. In step S106, data is regenerated at a magnification, which is displayed as the display magnification of the print preview dialog 301, using the preview data generated in step S104.

Finally, in step S107, the print image 303 in the print preview dialog 301 is displayed using the preview data. Note that a preview image displayed without resizing the preview data generated in step S104 is generated at a resolution equal to the number of dots per inch, which is displayed on the display device, using the print data. Hence, an image with the same size as the print size is displayed on the display device.

According to the above-mentioned embodiment, the print result can be confirmed based not only on its type of printing on a printing medium but also on its actual size, as shown in FIGS. 4A and 4B. This means that the convenience of the user in a preview improves. In this embodiment, a large-format printer which prints on a printing medium with A0 or B0 size is used, so a display device having a large display screen is desirably used for a preview with an actual size. However, such a display device having a large screen size is expensive, so a display device having a relatively small screen size may be used. In this case, a screen scroll function may be provided to display a print image with an actual size while scrolling each part of this image.

Also, if the host stores pieces of information of the number of pixels and the size of a display device used by the user, they can automatically be acquired without requiring a user's operation; otherwise, they can be input by a user's operation. This makes it possible to acquire the display resolution that is the number of pixels displayed per inch for every display device, thus generating a preview image which matches the display resolution. Further, as long as the display resolutions of display devices corresponding to a plurality of environments used by the user are stored, a preview image which matches the display resolution can be generated in accordance with a simple procedure.

As has been described above, according to this embodiment, an apparatus which has the above-mentioned functions and is used for a print preview can match the size of preview display and that of the print result on a display device in any desired environment used by the user. This makes it possible to preview an image with an actual size. Also, when the printer 2 performs processing as mentioned above, the printer 2 receives print data from the host 1, and then stores it in its external storage device 205. Subsequently, pieces of information of the size and resolution of a monitor are acquired in accordance with the same procedure as that used in the host 1, and a print preview is performed at the same size as that in printing in accordance with these pieces of information.

Also, although the entire region on a screen of each display device is used for a print preview in the above-mentioned example, the present invention is not limited to this. A predetermined display area of the entire region on the display device may be used for a print preview. In this case, pieces of information corresponding to the display area for a print preview are input on the screens shown in FIGS. 5A, 5B, 6A, and 6B.

### Other Embodiment

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium). Also, this program may be executed by a single computer or cooperatively executed by a plurality of computers. Moreover, not all of the above-mentioned processes need to be implemented by software, and some or all of them may be implemented by hardware.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-168426, filed Jul. 27, 2010, which is hereby incorporated by reference herein in its entirety.

What is claimed is:

1. A printing control apparatus which controls to perform a preview of an image on a screen of a display device before the image is printed on a printing medium, comprising:
an acquisition unit configured to acquire a number of pixels and a size of the screen of the display device, which allow the preview thereon;
a calculation unit configured to calculate a display resolution used for the preview on the display device, based on the number of pixels and the size which are acquired by said acquisition unit;
an input unit configured to input image data used to print the image;
a generation unit configured to generate preview data used for the preview, based on the image data input by said input unit and the display resolution of the display device calculated by said calculation unit; and
a display control unit configured to control the display device to display a preview image by outputting the preview data generated by said generation unit to the display device.

2. The apparatus according to claim 1, further comprising:
a storage unit configured to store the number of pixels and the size in association with each of a plurality of display devices; and
a selection unit configured to select one of the plurality of display devices,
wherein said acquisition unit acquires, from said storage unit, a number of pixels and a size of the display device selected by said selection unit.

3. The apparatus according to claim 1, further comprising a user interface unit configured to accept the number of pixels and the size input by a user,
wherein said acquisition unit acquires the number of pixels and the size accepted via said user interface unit.

4. The apparatus according to claim 1, further comprising an accepting unit configured to accept a display magnification of the preview,
wherein said generation unit generates preview data in accordance with to the display magnification accepted by said accepting unit.

5. The apparatus according to claim 4, further comprising a resizing unit configured to resize the image data in accordance with the display magnification accepted by said accepting unit if the display magnification is not 100%.

6. The apparatus according to claim 1, wherein the apparatus integrates the display device.

7. The apparatus according to claim 1, wherein the display device includes an external device.

8. A non-transitory computer-readable storage medium storing a computer-executable program, the computer-executable program comprising:
acquiring a number of pixels and a size of a screen of a display device, which allow a preview thereon;
calculating a display resolution used for the preview on the display device, based on the acquired number of pixels and the acquired size;
inputting image data used to print an image;
generating preview data used for the preview, based on the input image data and the calculated display resolution of the display device; and
controlling the display device to display a preview image by outputting the generated preview data to the display device.

9. A printing apparatus connected to a printing control apparatus according to claim 1.

10. A printing apparatus which integrates a printing control apparatus according to claim 1.

11. A print preview method for a printing control apparatus which controls to perform a preview of an image on a screen of a display device before the image is printed on a printing medium, comprising:
acquiring a number of pixels and a size of the screen of the display device, which allow the preview thereon;
calculating a display resolution used for the preview on the display device, based on the acquired number of pixels and the acquired size;
inputting image data used to print the image;
generating preview data used for the preview, based on the input image data and the calculated resolution of the display device; and
controlling the display device to display a preview image by outputting the generated preview data to the display device.
